(19) United States
(12) Patent Application Publication
(10) Pub. No.: US 2008/0288288 A1
(43) Pub. Date: Nov. 20, 2008

(54) METHODS AND APPARATUS TO GENERATE RULES FOR CLINICAL LAB RESULTS

(76) Inventors: Michael Thomas Randazzo, South Jordan, UT (US); Randy Kent Secrist, West Jordan, UT (US); David John Steiner, Kaysville, UT (US)

Correspondence Address: PATRICK W. RASCHE (12553 - 1000), ARMSTRONG TEASDALE LLP, ONE METROPOLITAN SQUARE, SUITE 2600, ST. LOUIS, MO, 63102-2740, US

(21) Appl. No.: 11/748,117

(22) Filed: May 14, 2007

(51) Int. Cl. G06Q 50/00

(52) U.S. Cl. 705/3

(57) ABSTRACT

A computer-based method for generating rules for a clinical decision support system includes displaying a selected lab result for a patient, receiving a command from a user to create a rule using the selected lab result, and displaying questions and receiving answers from the user concerning future values of the selected lab result and/or trends of the selected lab result. The method further includes generating a rule for notifying the user based upon the future values of the selected lab result and/or trends of the selected lab result, in accordance with the received answers from the user.

### BACKGROUND OF THE INVENTION

This invention relates generally to clinical decision support systems, and more particularly to methods and apparatus for generating rules for such systems.

CDSSs are typically designed to integrate a medical knowledge base, patient data and an inference engine to generate case specific advice. Components of a clinical decision support system (CDSS) include a dynamic (medical) knowledge base and an inference mechanism, which usually comprises a set of rules derived from the experts and evidence-based medicine. The CDSS can be expert system, an artificial neural network, or a combination of both.

Measurements and/or estimates of the amount of time required to write rules for CDSSs have be made and reported. In at least one published paper, the time required to write rules for seven clinical conditions has been reported as one week, while the average cost of writing rules for one condition was reported as being between 6 and 20 hours, including the time to specify task-specific and representation-specific knowledge as rules, and to debug/test the rules. [“The Role of Domain Knowledge in Automating Medical Text Report Classification,” 2000, pages 13-14, by Adam B. Wilcox, Ph.D. and George Hripcsak, M.D., M.S. Reprints available from Adam Wilcox, Ph.D., Medical Informatics, Intermountain Health Care, 4646 W. Lake Park Blvd, Salt Lake City, Utah 84120 or at www.dbmi.columbia.edu/˜hripcsa/Publication/2003_JAMIA_Wilcox_MLtextrepr.doc]. Thus, many physicians and end users do not take the time required to learn and/or write rules for specific patients in an arcane programming language. These physicians and end users must settle for general rules that have been programmed into a CDSS by someone else.

However, a physician or user may care about, for example, a 2 or 3% decrease in a clinical parameter in a particular patient being monitored because a trend concerning this parameter has been noted in this patient. Without knowing how to write rules for particular patients, the physician or user would not be able to use known CDSS systems effectively for spotting such a decrease.

### BRIEF DESCRIPTION OF THE INVENTION

In one aspect, some configurations of the present invention provide a computer-based method for generating rules for a clinical decision support system. The method includes displaying a selected lab result for a patient, receiving a command from a user to create a rule using the selected lab result, and displaying questions and receiving answers from the user concerning future values of the selected lab result and/or trends of the selected lab result. The method further includes generating a rule for notifying the user based upon the future values of the selected lab result and/or trends of the selected lab result, in accordance with the received answers from the user.

In another aspect, some configurations of the present invention provide an apparatus for generating rules for a clinical decision support system. The apparatus includes a computer having a processor, memory operatively coupled to the processor, a display or printer operatively coupled to the processor, and an input device for a user operatively coupled to the processor. The computer is configured to receive user-selected laboratory results for a patient. The apparatus is configured to display a selected lab result for a patient, receive a command from the user to create a rule using the selected lab result, and display questions and receive answers from the user concerning at least one member of the set consisting of future values of the selected lab result and trends of the selected lab result. The apparatus is further configured to generate a rule for notifying the user based upon said at least one member of the set consisting of future values of the selected lab result and trends of the selected lab result, in accordance with the received answers from the user.

In yet another aspect, some configurations of the present invention provide a medium or media having recorded thereon instructions configured to instruct a processor to display a selected lab result for a patient, receive a command from the user to create a rule using the selected lab result, and display questions and receive answers from the user concerning at least one member of the set consisting of future values of the selected lab result and trends of the selected lab result. The instructions are further configured to instruct the processor to generate a rule for notifying the user based upon said at least one member of the set consisting of future values of the selected lab result and trends of the selected lab result, in accordance with the received answers from the user.

It will be appreciated that some configurations of the present invention provide a user with a simple interface for generating rules to monitor a patient's lab results in a timely manner without adversely affecting a user's workflow, particularly when that user is a hospital caregiver such as a nurse or a physician.

### BRIEF DESCRIPTION OF THE DRAWINGS

FIG. 1 is a schematic of a rule generating apparatus.

FIG. 2 is a flow chart illustrating a method of generating and utilizing a rule.

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

### DETAILED DESCRIPTION OF THE INVENTION

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Configurations of the present invention allow users to dynamically create rules for clinical decision support systems (CDSS) by spotting a specific trend in a particular patient. For example, if the trend of a patient's measured blood pressure is going down and has fallen, say, 2%, some configurations allow the user to indicate who should be notified if this trend continues and how the notification should be sent. For example, if a physician observes notices something interesting about a measurement (such as a trend), the physician can dynamically create a rule based upon that observation with a few clicks of a mouse. Thus, a caregiver who needs to be informed, or who needs to notify someone else, can generate a rule specific for an individual patient based upon observations that may not have been apparent at the beginning of a course of treatment. Technical effects of some configurations of the present invention therefore include the generation of rules specific for an individual patient. Also, in some configurations of the present invention, technical effects include the generation of an electronic notification, such as an email or a pager message, to notify a user when indicated by one of these rules.

Configurations of the present invention are useful for all lab results. The lab results could be entered automatically, i.e., continuously electronically monitored, or monitored periodically. Typically, an order would be placed to check someone's potassium. The lab technician would come in, draw blood, or do whatever is needed, and send the specimen to the lab. When the lab gets the results, they would come through some interface into the system automatically.

Configurations of the present invention may, but need not include a large database. Some configurations may be a single computer monitoring a single patient and may be built into a single clinical instrument. However, some configurations utilize a large clinical database for a hospital or group of hospitals.

Some lab results of a patient may go up and down during the day and night. Some trends can be recognized as abnormal from these lab results and vital signs. Thus, some configurations of the present invention allow a user to tell the system what he or she is looking for. The rule generating engine or other module of a computer program can request and receive information from a user regarding lab results that are continuously increasing or decreasing, or lab results having values that are spiking or irregular in either direction. If values normally go up and down, some configurations of the present invention allow the user to define a normal range for the rule generating engine. For example, a patient's heart rate may normally goes up or down by 10 to 20 bpm, but a rule may be added by a user to provide an alert if the patient is in a relaxed state and the heart rate changes, say, by 100 bpm.

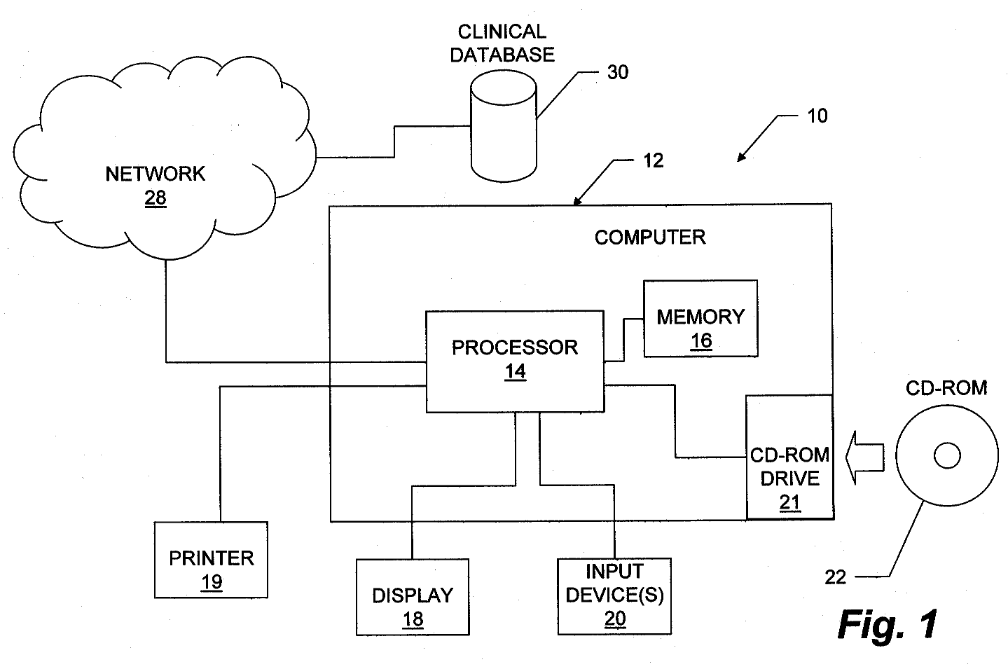

More particularly, in some configurations of the present invention and referring to FIG. 1, an apparatus 10 is provided for generating rules for a clinical decision support system. The apparatus includes a computer 12 having a processor 14, memory 16 operatively coupled to the processor, a display 18 and/or printer 19 operatively coupled to processor 14, and an input device 20 such as a keyboard, a mouse, and/or a touchscreen display 18 for a user. Each of memory 16, display and/or printer 19, and input device 20 is operatively coupled to processor 14. In addition, computer 12 may also have any known type of media reader such as a CD-ROM drive 21, a DVD-ROM drive (not illustrated), or a floppy disk drive (also not illustrated), or be able to accept and read devices such as USB flash memory, etc. (also not illustrated). Computer 12 is configured to receive user-selected laboratory results for a patient. For example, computer 12 may be operatively connected via a network 28 such as the Internet or another local or private intranet to a clinical database 30. In another configuration, computer 12 is operatively connected to a clinical diagnostic machine (not shown) or is an integral part of same. In yet another configuration, clinical data is input to computer 12 manually via input device 20. These various method for computer 12 receiving input data are not mutually exclusive and any combination of the several methods may be applicable to any particular configuration.

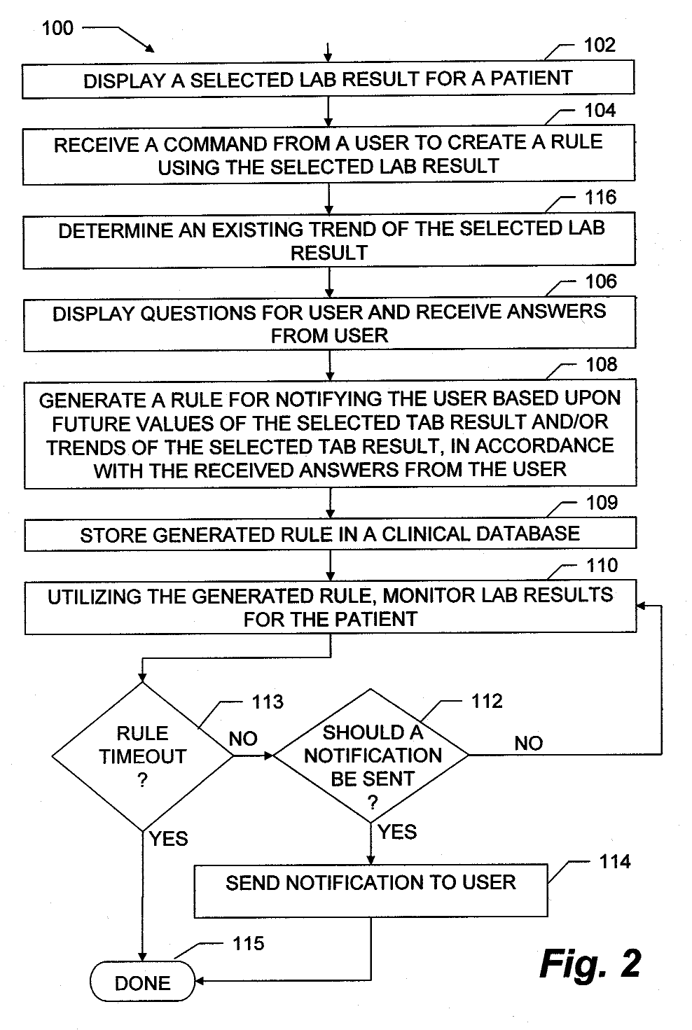

In some configurations of the present invention and referring to flow chart 100 of FIG. 2, apparatus 10 is configured to display, such as on display 18 or printer 19, a selected lab result for a patient at 102. Lab results may be obtained from internal memory 16, an attached laboratory apparatus, or an external database, including one reachable by network 28. The desired lab result is selected by the user using input device 20. In some configurations, a menu of lab results is displayed on a graphical user interface (GUI) on display 18 and the user selects a lab result from the menu. At 104, apparatus 10 next receives a command from the user to create a rule using the selected lab result. For example, the user clicks on a button labeled “Create Rule Using Selected Lab Result” using display 18 and a user input device 20.

After apparatus 10 receives the command to create a rule, computer 12 then controls display 18 or printer 19 to display questions and controls input device 20 to receive answers from the user at 106. The questions and answers concern future values of the selected lab result and/or trends of the selected lab result. The number of questions can be limited in variety in some configurations of the present invention because the types of rules that need to be generated may be limited. For example only, and without limitation, questions can include, “Notify if existing trend continues for _ minutes” (or hours, days, measurements, etc.) where the user checks a box next to the rule and fills in the blank. Another question that might be included is “Notify if lab result exceeds/is less than _,” where the user checks a box next to the rule, selects “exceeds” or “is less than,” and fills in the blank. These questions are selected to easily translate into a rule for the selected lab result. Then, at 108, computer 12 generates a rule for notifying the user based upon the future values of the selected lab result and/or trends of the selected lab result, in accordance with the received answers from the user.

At 110, some configurations of the present invention are further configured to monitor lab results for the patient utilizing the generated rule. The results may be monitored by connecting to the clinical database on a predetermined schedule, by receiving updated lab results electronically as they are updated, and/or by receiving lab results manually input via input device 20. The rule generated from user input is then interpreted by a rule execution module controlling computer 12. If the rule indicates that a notification should be sent at 112, then at 114, apparatus 10 generates a notification in accordance with the generated rule and the monitored lab results.

In some configurations of the present invention, software or firmware is provided that automatically finds a trend in the selected lab result and/or allows a user to click on multiple datapoints on display 18 to indicate a trend. For example, a user can call up a list of recent lab results for display. By way of example and not by way of limitation, the user may request a display of the five most recent potassium values. The caregiver observes that these values are slowly dropping by 0.1 with each measurement. The caregiver can select a multiple of 0.1 for generating a rule. A rule generator running in computer 12 calculates the trend and codes a rule that provides that if the next value of potassium result follows the trend is less than that which would have been predicted by the trend, a notification is sent out.

In some configurations of the present invention, the rule generator also requests and receives information in addition to lab values. For example, the rule generate may ask how to notify a caregiver, e.g., by email, by pager, etc. It may be particularly important to specify a method of contact if a shift is ending, for example.

For example, a potassium level below 5 is bad for a patient. But if the patient initially has a potassium level of 6, and subsequent readings are 5.9, 5.8, 5.7, the potassium level may eventually fall to 5. In this case, the user may want to specify that he or she be notified if the potassium level continues to fall at, say, the next datapoint, so that the user can do something about it before the potassium level reaches the “5” threshold. Also, in some configurations of the present invention, one of the questions that may be asked requests the user to input a threshold level for the selected lab result. In some configurations, a question that may be asked of a user is how many more datapoints are needed to decide that a trend is continuing. Thus, in some configurations of the present invention, the method further includes, at 116, determining an existing trend of the selected lab result for the patient. In generating a rule for use in notifying the user at 108, the method includes using the existing trend of the selected lab result to generate the rule.

In some configurations of the present invention, the questions for the end user include time limits for the generated rule to be operative. For example, one of the questions at 106 may be “Rule is to be operative for _ minutes” (or hours, days, lab tests, etc.). If the allotted time has expired at 113, the rule is rendered inoperative at 115. Otherwise, the lab results continue to be monitored at 114 and 110. Other questions that are included in some configurations of the present invention include a choice of notifying the end user when the monitored lab results are outside of specific limits or when the monitored lab results follow the determined trend, and a choice of being notified via email or via pager. Also, in some configurations of the present invention, at 109, the generated rule is stored in a clinical database.

It will be appreciated that, by proper programming of computer 12 of apparatus 10, method configurations of the present invention described above can be performed by apparatus 10. Programming instructions can, in some configurations, be provided on a machine readable medium or media (i.e., one or more medium, possibly, but not necessarily, all of the same type) such as a CD-ROM 22, for example. Medium or media 22 have recorded thereon instructions configured to instruct processor 14 to perform one or more method configurations of the present invention.

While the invention has been described in terms of various specific embodiments, those skilled in the art will recognize that the invention can be practiced with modification within the spirit and scope of the claims.

What is claimed is:

1. A computer-based method for generating rules for a clinical decision support system, said method comprising:
displaying a selected lab result for a patient;
receiving a command from a user to create a rule using the selected lab result;
displaying questions and receiving answers from the user concerning at least one member of the set consisting of future values of the selected lab result and trends of the selected lab result; and
generating a rule for notifying the user based upon said at least one member of the set consisting of future values of the selected lab result and trends of the selected lab result, in accordance with the received answers from the user.

2. A method in accordance with claim 1 further comprising:
monitoring lab results for the patient utilizing the generated rule; and
generating a notification in accordance with the generated rule and the monitored lab results.

3. A method in accordance with claim 1 further comprising determining an existing trend of the selected lab result for the patient, and wherein said generating a rule for notifying the user further comprising using the existing trend of the selected lab result to generate said rule.

4. A method in accordance with claim 1 wherein the questions for the end user include time limits for the generated rule to be operative.

5. A method in accordance with claim 1 wherein the questions for the end user include a choice of notifying the end user when the monitored lab results are outside of specific limits or when the monitored lab results follow the determined trend.

6. A method in accordance with claim 1 wherein the questions for the end user include a choice of being notified via email or via pager.

7. A method in accordance with claim 1 further comprising storing the generated rule in a clinical database.

8. A method in accordance with claim 1 wherein said displaying a selected lab result for a patient further comprises accessing a clinical database to obtain the selected lab result.

9. An apparatus for generating rules for a clinical decision support system, said apparatus comprising:
a computer having a processor, memory operatively coupled to said processor, a display or printer operatively coupled to said processor, an input device for a user operatively coupled to said processor, and said computer configured to receive user-selected laboratory results for a patient;
and said apparatus configured to:
display a selected lab result for a patient;
receive a command from the user to create a rule using the selected lab result;
display questions and receive answers from the user concerning at least one member of the set consisting of future values of the selected lab result and trends of the selected lab result; and
generate a rule for notifying the user based upon said at least one member of the set consisting of future values of the selected lab result and trends of the selected lab result, in accordance with the received answers from the user.

10. An apparatus in accordance with claim 9 further configured to:
monitor lab results for the patient utilizing the generated rule; and
generate a notification in accordance with the generated rule and the monitored lab results.

11. An apparatus in accordance with claim 9 further configured to determine an existing trend of the selected lab result for the patient, and to generate a rule for notifying the user, said apparatus configured to use the existing trend of the selected lab result to generate said rule.

12. An apparatus in accordance with claim 9 wherein the questions for the end user include time limits for the generated rule to be operative.

13. An apparatus in accordance with claim 9 wherein the questions for the end user include a choice of notifying the end user when the monitored lab results are outside of specific limits or when the monitored lab results follow the determined trend.

14. An apparatus in accordance with claim 9 wherein the questions for the end user include a choice of being notified via email or via pager.

15. An apparatus in accordance with claim 9 further configured to store the generated rule in a clinical database.

16. An apparatus in accordance with claim 9 wherein to display a selected lab result for a patient, said apparatus further configured to access a clinical database to obtain the selected lab result.

17. A medium or media having recorded thereon instructions configured to instruct a processor to:
display a selected lab result for a patient;
receive a command from the user to create a rule using the selected lab result;
display questions and receive answers from the user concerning at least one member of the set consisting of future values of the selected lab result and trends of the selected lab result; and
generate a rule for notifying the user based upon said at least one member of the set consisting of future values of the selected lab result and trends of the selected lab result, in accordance with the received answers from the user.

18. A medium or media in accordance with claim 17 further having recorded thereon instructions configured to instruct the processor to determine an existing trend of the selected lab result for the patient, and to generate a rule for notifying the user, said apparatus configured to use the existing trend of the selected lab result to generate said rule.

19. An medium or media in accordance with claim 17 wherein the questions for the end user include time limits for the generated rule to be operative.

20. A medium or media in accordance with claim 17 wherein the questions for the end user include a choice of notifying the end user when the monitored lab results are outside of specific limits or when the monitored lab results follow the determined trend.
